(19) United States
(12) Patent Application Publication
(10) Pub. No.: US 2009/0006132 A1
(43) Pub. Date: Jan. 1, 2009

(54) Patient-specific electronic medical record and method for making same

(75) Inventors: Gopal Biligeri Avinash, Menomonee Falls, WI (US); Chirstopher David Unger, Brookfield, WI (US); David Thomas Gering, Waukesha, WI (US)

Correspondence Address: GE HEALTHCARE;c/o FLETCHER YODER, PC, P.O. BOX 692289, HOUSTON, TX, 77269-2289, US

(73) Assignee: General Electric Company

(21) Appl. No.: 11/824,092

(22) Filed: Jun. 29, 2007

(51) Int. Cl. G06Q 50/00

(52) U.S. Cl. 705/3

(57) ABSTRACT

A patient-specific electronic medical record may include past imaging information, as well as parameter settings, protocol identifications, and any other information extracted from the previous imaging data or derived from such data. The EMR may also include non-imaging data, such as clinical data, and results of various examinations performed of a non-imaging type. The electronic medical record may be used for a range or purposes, such as diagnosing patient conditions, recommending treatments, recognition of at-risk patients for pre-emptive and reactive care, and so forth. Moreover, the information in the EMR may be used directly for setting imaging system parameters in future imaging acquisition and post-acquisition processing.

### BACKGROUND

The present invention relates generally to the field of medical data and medical records. More particularly, the invention relates to a technique for building a patient-specific electronic medical record (EMR) based upon imaging and non-imaging data.

Medical records have long been fundamental to rendering of medical care. Historically, however, such records have been kept on paper and in paper files, with completely separate files being maintained by various participants in the medical care chain. Such paper files are still extremely useful and versatile. However, with the advent of more advanced networks and digital storage and imaging media, there has been a general movement towards electronic storage of at least some patient data.

Medical imaging, particularly diagnostic imaging, has become a cornerstone of medical practice in all fields, and generates vast quantities of data, not all of which is always useful for care providers. Such imaging has largely displaced interventional processes such as exploratory surgery, and has greatly enhanced the ability to detect and diagnose disease states, and to treat many different medical conditions. A range of diagnostic modalities are currently available to referring and treating positions, including magnetic resonance imaging (MRI), computed tomography (CT), digital X-ray, X-ray tomosynthesis, positron emission tomography (PET), and others. In many instances, more than one of these modalities may be key to understanding development of disorders in particular tissues of a patient, useful in performing accurate diagnosis and, ultimately, in rendering high quality medical care.

There has been little or no significant movement in the medical field towards true integration of imaging data with non-imaging data, such as clinical data. Improved techniques for integrating imaging systems with available data both from previous imaging sessions and with non-imaging data are therefore needed.

### BRIEF DESCRIPTION

The present invention provides novel techniques for mining, filtering, consolidating, structuring and integrating medical data designed to respond to such needs. The technique enables building of a patient-specific EMR in which data derived from medical imaging data, and from non-imaging data is stored. The EMR may be stored in a single location, or in a series of networked devices, so long as information is available for later access and analysis.

The EMR may include a wide range of imaging-related data or data derived from such data. For example, acquisition information, image reconstruction information, image processing information, image analysis information, and display and visualization information may all be included in the EMR, as well as metadata regarding algorithms, parameters, usage sequences, and so forth for any of these. Moreover, non-imaging data may be acquired by any suitable conventional means, and provided in whole or in part into the EMR.

Analysis of the data in the EMR may serve a range of purposes. For example, the data may be used to determine future imaging sequences that may be most useful in diagnosing a condition or confirming a diagnosis, as well as for eliminating potential candidate diagnoses. The information may also be used to directly or indirectly set imaging parameters, to select an imaging modality, to configure an imaging system, to configure a computer assisted detection or processing algorithm, and so forth.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical overview of an EMR-based medical image planning and control scheme in accordance with aspects of the present invention;

FIG. 2 is a more detailed diagrammatical representation of the scheme of FIG. 1 illustrating various imaging and non-imaging resources that can contribute to the EMR and be used for recommending or configuring imaging sessions or processing or analysis of imaging data;

FIG. 3 is a flow chart illustrating exemplary logic in the creation and use of the EMR for influencing future imaging;

FIG. 4 is a flow chart illustrating exemplary logic for recommending future imaging sessions based upon information from the EMR; and

FIG. 5 is a flow chart illustrating exemplary logic for setting parameters of an imaging or image processing system based upon information from the EMR.

### DETAILED DESCRIPTION

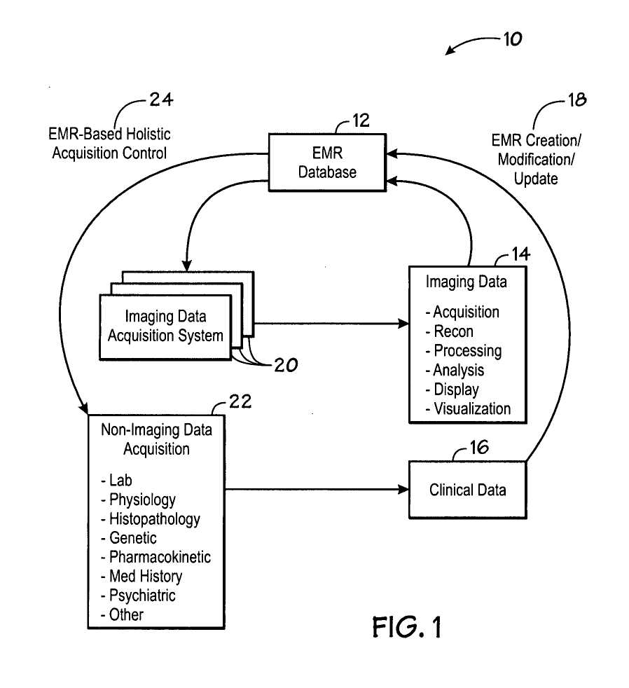

Turning now to the drawings, and referring first to FIG. 1, an EMR-influenced medical imaging scheme is illustrated generally and referred to by reference numeral 10. The technique is based upon creating and maintaining an EMR database designated generally by reference numeral 12. The database may be kept at a central location, or may be distributed among a number of computers, servers, or other devices. In general, the database may include information that can be associated with individual patients to determine imaging recommendations, imaging parameters, and so forth as described in greater detail below. The database may include structured data, indexed data, as well as actual image data that can be reconstructed for visualization by a viewer, typically a physician. The database may also include, as described in greater detail below, information derived from imaging sessions (e.g., including or pertaining to individual images and collections of images), as well as non-imaging data, such as clinical data.

The records in the EMR may be acquired in any suitable manner, including those used for generating conventional electronic medical records. In the arrangement illustrated in FIG. 1, for example, imaging data may be fed into the EMR, or data derived from imaging data. As indicated by reference numeral 14, such data may include acquisition information, reconstruction information, processing information, analysis information, and display and visualization information. As will be appreciated by those skilled in the art, acquisition settings will typically depend upon individual modalities employed for imaging sessions. These might include, for example, MRI systems, CT systems, PET systems, digital X-ray systems, ultrasound systems, SPECT systems, tomosynthesis systems, and so forth. Increasingly, moreover, some of these systems may be combined during imaging sessions and even used during surgical interventions. The acquisition information will commonly include information relating to particular anatomies imaged, settings and parameter inputs used during the imaging session, and so forth. Where image data formatting conforms to DICOM standards, certain of this information may be available from one or more headers included in an image dataset.

Reconstruction information may include actual data or metadata used for particular key algorithms, parameters and usage sequences employed in image reconstruction. Depending upon the imaging modality, a number of reconstruction techniques may be available. By way of example, in CT imaging, various types of back projection, filtered back projection, weighting techniques, and so forth may be available for producing useful images. Similarly, in MRI technologies, reconstruction of images, such as for T1, T2, TE and other weightings may be available depending upon the imaging protocol (e.g., pulse sequence description) employed.

Processing information may also include actual processing parameters and metadata regarding key algorithms, parameters and usage sequences employed during image data processing. In certain contexts, and depending again upon the modality and the parameters used during image data acquisition, processing parameters may be set to emphasize specific tissues and conditions, to highlight certain tissues and structures, to hide or de-emphasize certain structures, and so forth. Such image processing information may be set during the image acquisition itself, but in many instances will be determined when images are viewed and processed in a post-acquisition phase.

Image analysis information may similarly include parameters set during image analysis, such as by one or more computer assisted algorithms. The information may also include identification of the particular algorithms employed for analysis, usage sequences and results of the analyses, including spatial, temporal, qualitative and quantitative results. As will be appreciated by those skilled in the art, a wide range of computer assisted diagnosis, processing, segmentation, and other algorithms are currently available, and extremely useful algorithms are still being developed. These may be called upon for analysis purposes, such as to detect and identify, to segment, to quantify, compare and otherwise analyze specific tissues, anomalies, disease states and so forth, detectable in image data.

Finally, various display and visualization algorithms may be utilized to display images to human readers, but also to visualize certain tissues, such as through three-dimensional visualization techniques, cine techniques, and so forth. Where such information is available, the information itself, or metadata regarding key algorithms, parameters and usage sequences may be stored in the EMR database.

It will be apparent that not all of the information regarding imaging will need to be stored in the EMR database. However, extremely useful information for recommending and improving subsequent imaging may be gleaned from many details present in imaging data, or that may be derived from imaging data. These will not only include settings, or even identification of systems used for imaging, but such factors as patient preferences, susceptibilities of patients to conditions and the imaging room, the weight or size of patients, patient fears and phobias that may affect or render difficult, or conversely, facilitate imaging. Where such information can be captured and stored in the EMR database, the processes described below may draw upon the information for subsequent imaging.

As noted above, a wide range of clinical data 16 may also be included in the EMR database. Such clinical data may be referred to in the present context more generally as non-imaging data. The clinical data may be collected in any conventional manner, including by interviews with patients, from forms filled by patients, from insurance companies, laboratory analyses on collected tissue samples, genetic analyses on tissue collected from the patient, and so forth. More generally, the clinical data may include any patient-related information of a non-imaging nature. Where such data is available, it too may be entered into the EMR database 12.

In general, the creation of the EMR database 12, referred to generally by reference numeral 18, may progress in multiple stages over long periods of time. Indeed, the ultimate creation, modification and update of the EMR database 12 may be an additive or iterative process building upon existing data, and adding data as it becomes available, typically through rendering of medical attention to individual patients. The EMR database may collect this information in a manner that permits it to be shared, while protecting the identity of individual patients from unwarranted access. Thus, access to the EMR database, or to one or more computers or servers that comprise the database may be limited both for modification of the database, and access to the information for legitimate usage in manners described below.

In accordance with the present techniques, the data stored in the EMR database 12 is utilized to influence subsequent care provided to the patient, and particularly for medical imaging purposes. For example, information relating directly to parameter set on various modality imaging equipment may be drawn directly from the EMR database and used to configure and imaging system of the same or similar type. Moreover, certain portions of the information present in the database may be used for similar purposes, although this information was not previously used in imaging sequences. For example, as described more fully below, such factors as patient susceptibility to conditions in the imaging facility, patient phobias, patient weight and size, and so forth, collected from non-imaging resources, may be employed for subsequently setting imaging equipment to optimize acquisition of image data. Similar factors, and indeed any factors present in the EMR database 12 may be used for subsequent reconstruction, processing, analysis, display and visualization of images based upon subsequently collected image data. Thus, the EMR database 12 may directly affect the selection of modalities and protocols for subsequent imaging, and the handling of imaging data, as indicated generally by reference numeral 20 in FIG. 1.

In a similar manner, the EMR database 12 may be used to determine whether additional non-imaging data can be or should be acquired, and to identify which types of data may be of the most use in rendering medical attention to the individual patient. As indicated by reference numeral 22 in FIG. 1, a non-exhaustive list of such data sources may include laboratory analysis, physiological examinations, histopathological examinations, genetic evaluations and decoding, pharmacokinetic examinations, psychiatric examinations, and so forth. More generally, any information that may be useful in the patient history may be collected and subsequently entered into the EMR where appropriate. Such information may be indicative, for example, of predispositions to specific medical conditions and disease states, demographic risk factors, family risk factors, genetic risk factors, and so forth. As described below, such information may be analyzed and employed for determining whether subsequent imaging would assist in evaluating a patient condition, as well as in recommending the modality, protocol, and even settings to be used for such image data acquisition.

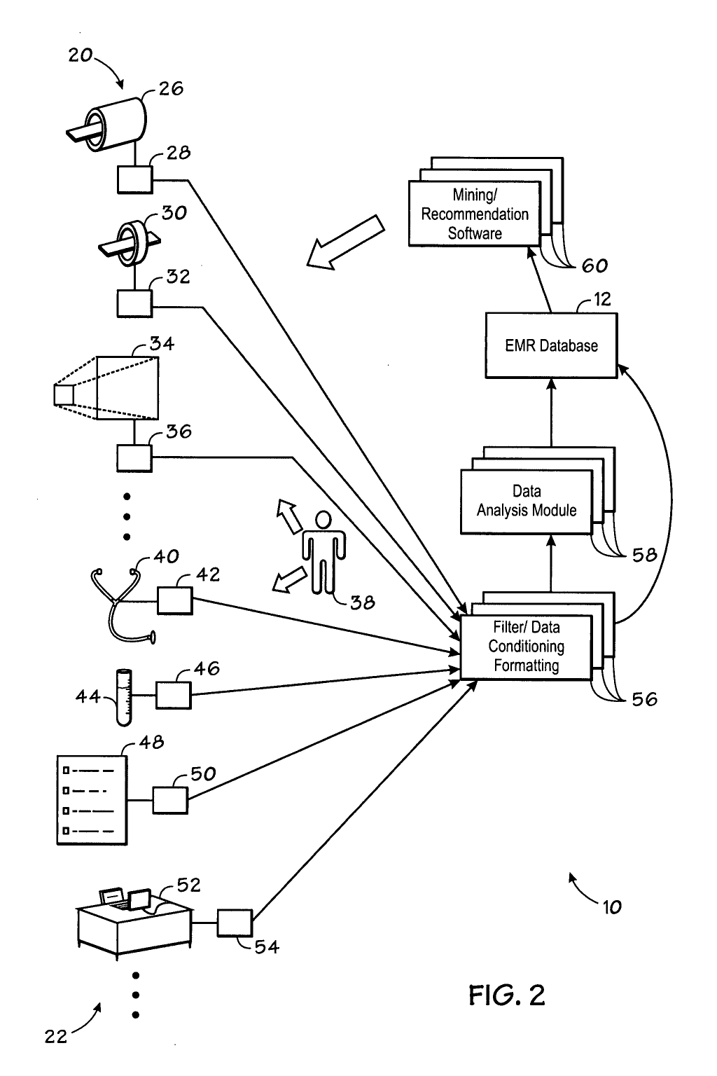

FIG. 2 illustrates in somewhat greater detail the arrangement shown in FIG. 1. In particular, the EMR database 12 is populated with information from a range of resources as described above. In the illustration of FIG. 2, these include imaging resources 20 and non-imaging resources 22.

The imaging resources 20 may include any range of imaging systems, including systems of various modality, physical characteristics, manufacture, and so forth. Moreover, the imaging resources may employ any suitable imaging protocols and parameters, all of which may be associated with individual imaging sequences so as to enhance the quality of the information available for subsequent use from the EMR database. In the illustrated embodiment, for example, several such imaging systems are represented symbolically, including an MRI system 26. The system 26, in manners well-known in the art, will collect image data based upon specific pulse sequence descriptions, and may reconstruct images by 2D fast Fourier transforms, as well as certain other reconstruction techniques where the acquisition protocols permit. In general, an image data acquisition controller or interface 28 will be associated with the system for setting the image parameters, selecting image protocols, and collecting image data.

Similarly, FIG. 2 illustrates a CT system 30 associated with a controller or interface 32, and a digital projection X-ray system 34 associated with its controller or interface 36. These systems will also be configured to perform image sequences in accordance with their unique physics and available imaging protocols. Imaging data collected, as well as parameters set for image acquisition, and even metadata relating to such parameters may be extracted from the systems and provided for inclusion in the EMR database. The symbols illustrated in FIG. 2 are, of course, not intended to be limiting, but are mere examples of the types of imaging resources from which data may be collected. As noted above, other modalities of imaging resources may include PET imaging systems, ultrasound imaging systems, SPECT imaging systems, and so forth.

The non-imaging resources may similarly include any range of available techniques for acquiring information relating to the patient. These will typically include clinical examinations, as represented generally by reference numeral 40, which may encode data through an appropriate computer interface represented by reference numeral 42. Such computer interfaces may be as simple as data entry into admission records, insurance records, patient queries, and so forth. Such information may presently be included in limited electronic medical records, but will serve the enhanced purpose in the present invention of guiding future image acquisition, reconstruction, analysis, display and visualization. Similarly, laboratory analyses may be performed as indicated at reference numeral 44, and the results of such analyses may be digitized in an interface 46, such as at a laboratory in which the analyses are performed. Reference numeral 48 represents, generally, any type of medical history records that may be partially or fully computerized by an appropriate interface 50. Symbol 52 represents, generally, various consultations, psychiatric examinations, and so forth that may be performed, and which may be subject to computerization by an appropriate interface 54, completed by the examining physician or a support staff. Other non-imaging resources, as noted above, may include physiological examinations, histopathological examinations, genetic examinations, pharmacokinetic examinations and so forth.

In general, the patient 38 is the center of the present invention and medical services process. That is, the patient 38 may interact with any one of the imaging and non-imagining resources through imaging sessions, clinical visits, or in any other manner. It should be noted, for example, that in certain contexts the patient may interact with such resources without a medical visit, such as where patients are provided with ambulatory monitors, home monitors, and the like.

To the extent that the data available from the imaging and non-imaging resources can be computerized or otherwise made available, filter and data conditioning and formatting modules, represented generally by reference numeral 56, may provide for extraction of data from the raw data. That is, data may be derived from the imaging and non-imaging resources to reduce the data to select specific types of information or fields that are most useful in subsequent determination image acquisition, reconstruction, processing, analysis, display and visualization. The filter and data conditioning and formatting module 56 may be present in the interfaces for each of the resources, or these may exist as computer code in separate computers or servers designed to refine or derive data from the provided data suitable for inclusion in the EMR database 12. It should be noted that the data provided to the EMR database may include the raw or received data itself with little or no filtering. Thus, the EMR database may include actual image data that can be reconstructed into useful images, and/or data derived from the image data, such as parameter settings, protocol identifications, and so forth.

Information from the filter and data conditioning and formatting modules 56 may be provided directly to the EMR database 12, or may be further analyzed by data analysis modules 58. Such modules may, for example, structure the data, identify useful data for inclusion in the database, while excluding other data, and so forth. Moreover, analysis may involve computation of values or other data from the provided data, such as to determine ranks, risks, correlations, and so forth.

Ultimately, data mining and recommendation software 60 is designed to extract useful information from the EMR database 12 and to use this information for such purposes as recommending subsequent imaging sequences, setting and adjusting parameters on imaging equipment, setting parameters for image reconstruction, processing, analysis, display and visualization. Examples of the use of the EMR database data for such purposes are provided below. In general, the mining and recommendation software 60 may function on the same computer or set of computers on which the EMR database is located, or separate components of the software may be present on other computers or even on imaging systems themselves. For example, radiologists, specialists, treating physicians or even referring physicians desiring to make certain diagnoses or to rule out diagnoses may utilize such software to evaluate known information and to draw upon information from the EMR database to determine the most useful next steps in providing medical care to the patient. The software may make use of any suitable approach to accomplish this purpose, including use of expert systems, neural networks, specialized software for particular fields, body systems and disease states, and so forth.

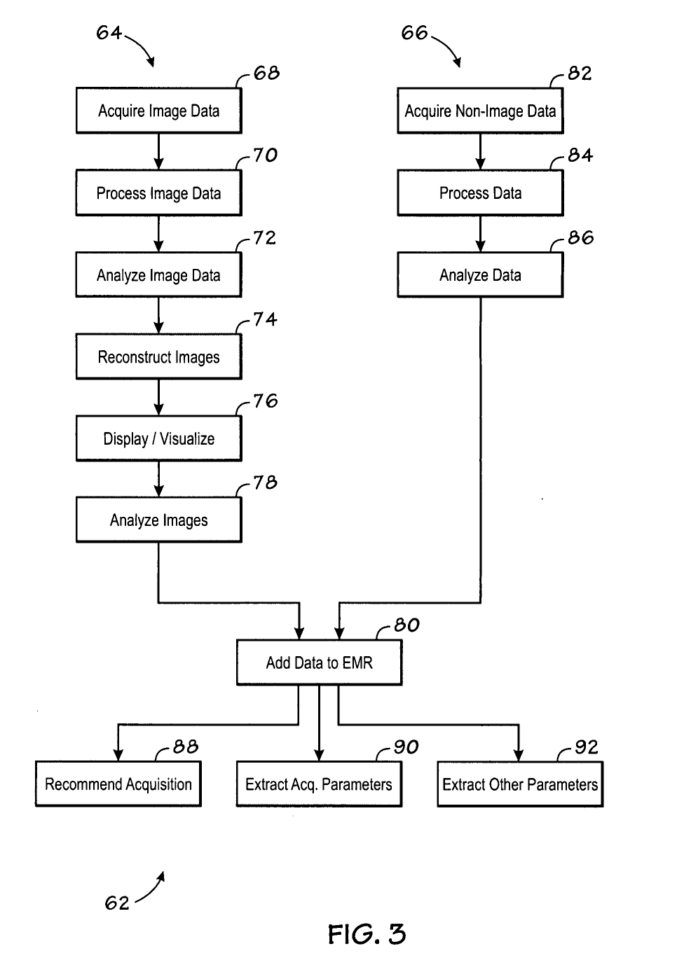

FIG. 3 illustrates exemplary logic for implementing the building, modification or updating of the EMR database and for use of the database as described above. In general, the logic, designated by reference numeral 62, may include steps for acquiring and processing image data as indicated by reference numeral 64, as well as steps for acquiring non-image data as indicated by reference numeral 66.

Where image data is available for processing and inclusion in the EMR database, such image data is first acquired as indicated at step 68. As noted above, the acquisition of image data will depend upon the particular imaging modality employed as well as any particular protocols, settings, and so forth. As will be appreciated by those skilled in the art, certain imaging systems allow for wide range of adjustment to accommodate patient preferences, variations in the types of images that may be acquired, variations to conform to prescriptions set forth by treating physicians and radiologists. These parameters, including identification of the protocols and any settings utilized during image data acquisition may be noted and stored for direct inclusion into the EMR or inclusion as simple metadata as described below.

At some point the image data is processed as indicated at step 70 and analyzed as indicated at step 72. Initial processing of image data is typically performed on the imaging system itself, while subsequent processing may be performed on the same or other systems. Initial image data processing typically includes adjustment of dynamic ranges, analog-to-digital conversion, filtering, and so forth. Subsequent processing may be much more detailed and specific, as may the analysis performed at step 72. For example, such analysis may be performed to identify specific structures encoded in the image data, enhance certain structures, and de-emphasize structures. By way of example, processing and analysis may include the extraction or segmentation of specific tissues of the heart, vascular tissues, lung tissues, growth or tumors, and pathologies.

As indicated at reference numeral 74, the imaging process generally includes reconstruction of useful images from the image data. As noted above, a number of reconstruction techniques are known, and in many cases a number of techniques are available for each imaging modality, depending upon the protocol and parameters utilized during image acquisition. At step 76 the reconstructed images may be displayed and visualizations may be created. These visualizations and displays are also subject to variations, such as for preferences in the manner in which images are displayed, the manner in which particular tissues are designated, highlighted, annotated, and so forth. At step 78, further analysis of the images may be performed, such as through conventional “reads” by radiologists. Similar analysis techniques and reads may be performed by computer algorithms for detection, segmentation, and identification of particular tissues, particularly those that might be indicative of disease states.

Some or all of the information available from the foregoing steps may be included in the EMR, as indicated generally by reference numeral 80 in FIG. 3. As noted above, the EMR may include the image data itself, in raw, processed or annotated form. Moreover, the EMR may include metadata, biographical data, as well as data indicative of parameter settings used during some or all of the steps of acquisition, processing, analysis, reconstruction, display and visualization.

In addition to imaging-related data, or data derived from such imaging data, the EMR will preferably include non-image data or data derived from such data. As indicated generally by reference numeral 66, the inclusion of such data in the EMR will typically begin with acquisition of the non-image data as indicated at step 82. As noted above, because the non-image data may originate in a wide range of resources, and may be collected in many different ways, such acquisition may vary from notes made during interviews or examinations, to the results of laboratory analyses, to the results of genetic sequencing and diagnostic testing, and so forth. In general, the acquisition is made by digitizing or summarizing the information in a manner that permits it to be stored in a computer readable medium. At step 84, the data may be processed. The processing may include data entry, but may also include summaries of the data, annotations and updates to the data, structuring of the data, and so forth. At step 86, analysis may be performed on the data, such as to associate elements of the data with one another, as well as potentially with other data not strictly relating to the individual patient. Thus, the analysis may include consideration of additional data for populations of patients, known information relating to conditions and disease states, known information relating to risk factors for medical conditions, and so forth. Both the raw and processed (derived) data may then be added to the EMR as again indicated at step 80.

It should be borne in mind that the EMR data may be changed and updated as new, more recent or improved data becomes available. The EMR may thus be considered a dynamic tool whose relevance and utility may be continuously improved over time.

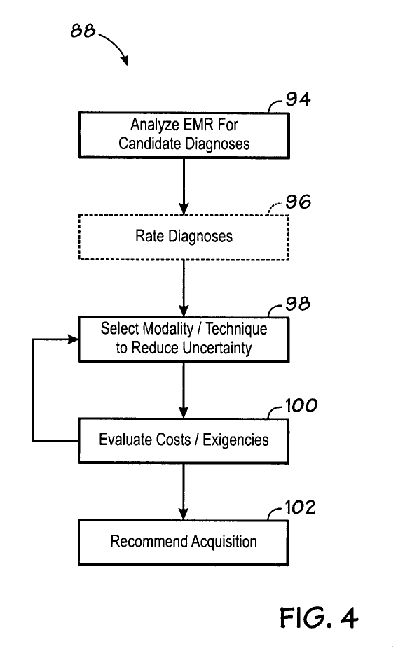

A number of uses may be made of the data in the EMR for influencing subsequent imaging. Three such uses are noted in FIG. 3. For example, as indicated at step 88, the data in the EMR may be utilized to recommend subsequent image data acquisition. Examples of how such recommendations may be made are provided below with reference to FIG. 4. Moreover, as indicated at step 90, acquisition parameters may be extracted directly from the EMR, or may be derived from the information in the EMR. For example, if specific parameters were utilized in a previous CT scan, based, for example, on a specific patient anatomy and patient weight or size, these parameters may again be utilized for subsequent examinations and may be set directly into a CT scanner during the subsequent examination, or accessed from the EMR to be set manually or semi-automatically. Many other parameters may be extracted directly from the EMR based upon previous examination sequences, depending upon the particular modality and the imaging protocol utilized. It should also be noted that non-imaging parameters may influence imaging settings, again using the example of the size or weight of a patient in setting X-ray system parameters. As indicated at step 92, other parameters may similarly be extracted from the EMR or derived from information in the EMR. As discussed more fully below, these may include identification of regions of interest which may be differently treated in subsequent imaging, indications of potential anatomies or anomalies encoded in previous image sequences, and so forth. It should also be noted that the parameters extracted at step 92 may include parameters not specifically related to image data acquisition, but more generally related to such phases of image data treatment as reconstruction, processing, analysis, display and visualization based upon collected image data. Any or all of these may be subsequently based upon the information stored in the EMR. By way of example, the EMR information may be particularly useful for ambulatory ER care where time is critical and the ability to the EMR to make available various types of data from various resources and for various purposes may lead to more effective and time-efficient patient care.

FIG. 4 represents exemplary logic for recommending a subsequent imaging session based upon information contained in the EMR. It will be noted that the recommendation of the subsequent imaging session may include recommendation of particular modalities as well as particular protocols within these modalities that may be helpful in rendering high-quality medical care.

The logic of FIG. 4, in this particular example, begins with step 94 where the EMR is analyzed for various candidate diagnoses. In this particular example, a subsequent imaging session is recommended to refine potential diagnoses and to focus on either eliminating some of the candidate diagnoses or increasing a level of certainty of one or a few of the candidates. In a presently contemplated embodiment, the logic of FIG. 4 implements an exemplary algorithm used to determine the acquisition or reconstruction or display parameters or a combination of these that may enhance the distinguishability between candidate diagnoses. An exemplary algorithm of this type may be considered a “minimum entropy” algorithm. Other criteria for holistic optimization of acquisition, reconstruction and display parameters may be contemplated, although only the minimum entropy approach is described in detail here. The approach is particularly suitable to various computer assisted diagnosis or processing tools that may be integrated into the EMR or used in conjunction with the EMR and that may have rendered several potential diagnoses for a patient condition.

As a result of step 94, for the present example it may be assumed that the EMR contains a list of potential remaining diagnoses, which the caregiver would like to distinguish or refine. By way of example only, such diagnoses relating to a symptom of chest pain may indicate several possible clinical conditions including pulmonary embolism, myocardial infarction, coronary artery disease, and so forth. A CT exam might be prescribed to distinguish which of these is the most likely diagnosis. As indicated at step 96, this process may include likelihood rating of each candidate diagnosis, such as based upon output of a computer assisted diagnosis or processing algorithm, or by inputs by a physician, radiologists or other specialists.

As indicated at step 98, the algorithm may then evaluate, given the information available in the EMR, which modality and/or imaging technique would provide the best differentiation between remaining diagnoses. For example, a CT-based acquisition technique might be good in theory in distinguishing between remaining diagnoses, but a previous X-ray acquisition might have already supplied the vast majority of the diagnostic value available from such modalities. Accordingly, a more appropriate next step might be to forego CT imaging and perform magnetic resonance imaging or imaging via a functional modality such as PET/CT or SPECT.

Moreover, the algorithm may create a matrix of possible diagnoses correlated with possible next diagnostic steps in terms imaging, image processing, reconstruction, analysis, display or visualization. Each element in the matrix could represent a remaining likely certainty or uncertainty of a diagnosis for a particular disease mechanism (i.e., definitely ruled in or definitely ruled out being of zero uncertainty). An information quality or entropy metric (e.g., the sum of the natural logarithm of the uncertainties) could be taken for the likely state after each modality or imaging technique. The modality or technique with the lowest entropy score (i.e., providing the lowest uncertainty or the greatest information) would receive the greatest value and would be selected for the recommendation.

Other considerations may be included in this evaluation, such as the considerations of cost and other exigencies, as indicated at step 100 in FIG. 4, and these may influence or change the selected imaging modality or imaging technique. For example, a value could be weighted against a patient-specific “cost”. For a pediatric patient, by way of example, radiation dose could be weighted more heavily than for an older patient. Financial costs, moreover, of specific examinations may be weighted, particularly if such costs are sensitive aspects of the patient care or insurance benefits. Time costs may also be considered. For example, if certain imaging modalities in the institution or region where a patient is located are fully booked, and the diagnosis is particularly time sensitive, such factors may be included in the recommendation (e.g., MRI or PET/CT may provide better information, but with a longer wait time and available CT systems may be a better choice for a prompt response which might be critical to confirming or eliminating one of the diagnoses). Still further, additional information used in making recommendations might include demographic information stored in a demographic database. Where such information indicates that a particular patient (for whom the EMR is built and kept) is at risk for a particular condition, for example, the recommended imaging, processing, analysis or treatment could be altered based upon this data. By way of example, such information might indicate that, while a particular course of action is not generally recommended, or would have a lower priority, a particular recommendation may be made due to the detection of similar conditions in a geographic area or population.

Finally, at step 102 a recommendation may be made for subsequent imaging data acquisition. Here again, it should be noted that while the acquisition is specifically called out in step 102, the recommendation may be made for specific protocols, modalities, or even types or manufacturers of imaging systems. Similarly, recommendations may be made for particular reconstruction techniques that can be used on existing data, or subsequently acquired data. The recommendations may also include recommended processing of existing or subsequently acquired image data, or for analysis of existing or subsequently acquired image data. The recommendation may further include identification of one or more computer assisted diagnosis, processing, segmentation or other algorithms that may assist in refining the diagnosis. Finally, the recommendation could also include indication of particular display or visualization techniques.

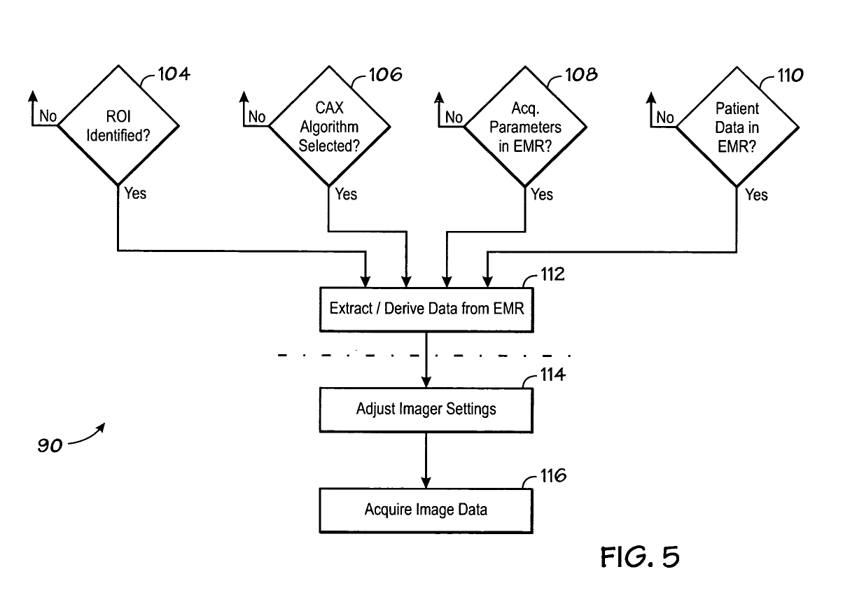

FIG. 5 illustrates exemplary logic that may be performed for influencing reconstruction, processing, analysis, display and visualization based upon existing or subsequently acquired image data and upon information available from the EMR. In the exemplary logic illustrated in FIG. 5, several queries may be made, in parallel or seriatim. By way of example, at query 104, it is determined whether a region of interest has been identified in the EMR from previous imaging sessions and from existing image data. Such image of interest may be identified manually or by automated or semi-automated computer assisted tools, and may identify anomalies, tumors, or any other anatomical features or regions of interest. At step 106, the logic may determine whether particular computer aided diagnosis, analysis, segmentation, identification or other tools have been used for past examination sequences, or whether such algorithms would be useful for subsequent analysis. At step 108 the logic may identify whether certain acquisition parameters are identified in the EMR for particular modalities and/or image data acquisition protocols. At step 110, the logic may determine whether certain patient data is available from the EMR, such as patient size, weight, preferences, phobias (e.g., sensitivities to close environments, noise), disabilities, known disease states or physical conditions, and so forth.

Where such information is identified in any one of these queries, or indeed other queries that may be performed at this stage, this information may be used to extract data or derive data from the EMR for use in performing subsequent imaging. Where no such information is available or is not identified in the queries, the subsequent imaging may proceed in a conventional manner. Step 112 summarizes the extraction and derivation of data from the EMR to use in subsequent imaging. For example, for dose intensive exams, such as CT, acquiring more dose intensive information at the regions of interest may provide enhanced resolution for imaging, segmentation, identification and differentiation of tissues, particularly tissues suspected of diseases. Such regions of interest may be automatically imported from results of computer assisted diagnosis, segmentation, analysis and other algorithms contained in the EMR. Examples of improved quality at the cost of dose, again, might be lower pixel or voxel pitch, higher resolution, or simply lower noise scans in the region or regions of interest. Similarly, for non-dose intensive exams, such as MRI, a scanner could acquire optimized scans for those regions of interest identified from the EMR. The scans may be selected or tuned (e.g., scanned parameters set) for higher acquisition times (e.g., leading to higher contrast or spatial resolution) for the regions of interest, or different types of imaging (e.g., different pulse sequences for MRI) could be used for specific regions of interest to confirm or to rule out specific conditions. Also, with specifically designed coils, body tissue heating (SAR) or nerve stimulation (PNS) could be avoided or minimized by concentrating on specific regions of interest. Moreover, particular slice orientations and spacing can be based on EMR data.

If specific computer assisted algorithms are indicated at step 106, data could be acquired specifically to enhance the performance of such algorithms. For example, for repeat studies, the specific acquisition parameters could be imported from prior exams stored in the EMR to optimize the probability of correct subtractions or comparisons to previously acquired data made by the computer assisted algorithm (e.g., detection, segmentation or identification algorithms). Depending upon the specific diagnosis or upon key candidate diagnoses, the proposed computer assisted analysis algorithm may function more effectively with input data that is optimized for uniform spatial resolution, high temporal resolution, high spatial resolution, for uniform CT number accuracy (in the case of CT) and so forth. Different acquisitions may have different optimizations, and these may be accommodated for the particular algorithm selected (e.g., a dual energy CT exam may provide improved or very accurate CT numbers, but suffer temporal resolution and dose impacts). By way of further example, MRI scanners provide the choice of many different pulse sequences, each optimized for producing image contrast between various tissues. Furthermore, each of these many sequences may be configured with several parameters. This provides great flexibility, but also great complexity for the operator. The proposed computer assisted detection, diagnosis, analysis, segmentation, or other algorithm, which may be selected from the diagnosis contained in the EMR, can be used to drive the suggested settings for the MRI pulse sequences an their parameters. For example, a computer assisted algorithm requiring brain segmentation could prescribe several sequences that optimize contrast between certain tissues, which would then be used as inputs into a multi-channel segmentation system. One image could maximize contrast between cerebral-spinal fluid and brain tissue, while another could optimize contrast between white matter and gray matter.

Similarly, if at step 108 particular acquisition parameters are identified, these may be used from previous examinations based upon the data stored in the EMR. By way of example, in the case of CT and contrast injections, the scanner may be optimized to employ a delay using a protocol such as one known as SmartPrep, marketed by General Electric Healthcare. Such delays in contrast dynamics could be imported from prior scans. In the case of a gated exam, as another example, respiratory gating and EKG gating may be employed with any average or anomalous patterns extracted from the prior exams imported to optimize the gating performance of future imaging session exams. As a further example, general patient morphology could be used, as indicated above, to optimize acquisition protocols. Currents employed for CT scanning, for example, could be optimized based upon prior patient exams. Again, in the case of CT imaging, single energy kV selection or dual energy scanning could be optimized based on anatomical parameters extracted from prior exams. These parameters could either be based on data from the prior exams, or could be stored as parameters in a patient atlas or anatomical model. Still further, MR corrections or special pulse sequences could be selected based upon physiological parameters extracted, such as patient weight, amounts of fat and locations of fat, cardiac sequence regularities and irregularities, and so forth.

In all of these examples of acquisition parameter settings, suggested acquisition parameters may be set directly on a similar imaging system, or these may be presented to a user. The presentation could be in the form of an interface page filled out according to the information available from the EMR to be used as a default option. Alternatively, such options may be highlighted using graphical queues, such as colors, fonts, and so forth. Other examples of information that could be extracted from the EMR to influence acquisition parameters and settings include hemodynamics data, perfusion data, contrast dynamics data, and cardiac function information. Similarly, acquisition parameters could be based upon previous clinical, patient history, lab and pathology tests, information of which is stored in the EMR. Lab data, for example, could include previous genomic or proteomic data, which could lead to a personalized prescription based on disease likelihood, rather than simply optimization spaced upon current anatomy or phenotype.

Similarly, at query 110 or FIG. 5, any other patient related data identified from the EMR may influence settings used during later image acquisition, processing, analysis, reconstruction, display or visualization. By way of example, here again, the acquisition may be controlled based upon genomic testing (e.g., clinical tests) in addition to the diagnostic imaging tests stored in the EMR. Increasingly, a number of diseases have been related to specific genetic correlations, and more diseases will be more closely related to such correlations in the future. For example, a person with a BRAC1 or BRAC2 genes can be automatically prescribed MR-based mammography acquisition rather than the traditional X-ray based mammography acquisition.

As also noted above, the extraction and use of the information from the EMR as summarized in FIG. 5 is not limited to setting image acquisition parameters, but may be used for post acquisition purposes. By way of example, image processing may be controlled during or after acquisition based upon such information. As post-processing of data (e.g., images) becomes faster and more automated, the processing can be performed “in-line” or prior to initial display on the computer console. For example, segmentation algorithms often require statistical priors, such as parameters of probability distributions (e.g., mean and standard deviation). The initial conditions for the adaptive computation of such parameters can be extracted from the EMR. Similarly, display and visualization parameters may be set or suggested based upon the EMR information. The settings used to display images during the acquisition could be extracted from the image data within the EMR. Any settings that are computed manually or via lengthy offline processing would benefit from the information in the EMR. Examples of such parameters might include window and level settings, background suppression, the opacity and transfer functions for volume rendering, and the culling of nuisance background structures for volume rendering.

Once such information has been identified in the EMR, the logic may allow for adjustment of the image or settings as indicated at step 114. As noted above, this may be done directly or past settings may be provided to a clinician or radiologist as a proposal or default option for the future imaging examinations. Finally, at step 116 the later imaging data acquisition is performed, along with subsequent processing, analysis, reconstruction, display and visualization.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for compiling a patient-specific electronic medical record comprising:
accessing imaging related data derived from a medical diagnostic imaging acquisition session for a patient;
accessing data derived from non-imaging related data for the patient; and
storing the imaging related and the non-imaging related data to form a patient-specific electronic medical record.

2. The method of claim 1, wherein the imaging related data includes data representative of imaging system parameters utilized during the imaging session.

3. The method of claim 1, wherein the imaging related data includes one or more candidate diagnoses made based upon the imaging related data.

4. The method of claim 1, wherein the imaging related data is extracted from image data sets acquired on a medical diagnostic imaging system.

5. The method of claim 1, wherein the non-imaging related data includes medical consultation data, psychiatric data, physiological data, histopathological data, genetic data, pharmacokinetic data, or a combination thereof.

6. The method of claim 1, wherein the electronic medical record is stored in a medical institution from which at least part of the imaging related data and the non-imaging related data originated.

7. The method of claim 1, comprising adding imaging related data or non-imaging related data or both to the electronic medical record over time as such data becomes available by interaction with the patient.

8. The method of claim 1, comprising filtering and structuring at least part of the imaging related or the non-imaging related data prior to storage in the electronic medical record.

9. A method for compiling a patient-specific electronic medical record comprising:
accessing imaging related data derived from a medical diagnostic imaging acquisition session for a patient;
accessing data derived from non-imaging related data for the patient;
filtering and structuring at least part of the imaging related or the non-imaging related data; and
storing the imaging and the non-imaging data in a patient-specific electronic medical record.

10. The method of claim 9, wherein the imaging related data includes data representative of imaging system parameters utilized during the imaging session.

11. The method of claim 9, wherein the imaging related data includes one or more candidate diagnoses made based upon the imaging related data.

12. The method of claim 9, wherein the non-imaging data includes medical consultation data, psychiatric data, physiological data, histopathological data, genetic data, pharmacokinetic data, or a combination thereof.

13. The method of claim 9, wherein the electronic medical record is stored in a medical institution from which at least part of the imaging related data and the non-imaging related data originated.

14. The method of claim 9, comprising adding imaging related data or non-imaging related data or both to the electronic medical record over time as such data becomes available by interaction with the patient.

15. At least one computer memory device comprising a patient-specific electronic medical record including imaging related data derived from a medical diagnostic imaging acquisition session for a patient, and data derived from non-imaging related data for the patient.

16. The device of claim 15, wherein at least a part of the imaging related data and the non-imaging related data is structured in the electronic medical record.

17. The device of claim 15, wherein the imaging related data includes data representative of imaging system parameters utilized during the imaging session.

18. The device of claim 15, wherein the imaging related data includes one or more candidate diagnoses made based upon the imaging related data.

19. The device of claim 15, wherein the non-imaging data includes medical consultation data, psychiatric data, physiological data, histopathological data, genetic data, pharmacokinetic data, or a combination thereof.

20. The device of claim 15, wherein the electronic medical record is stored in a medical institution from which at least part of the imaging related data and the non-imaging related data originated.

21. A system for compiling a patient-specific electronic medical record comprising:
means for accessing imaging related data derived from a medical diagnostic imaging acquisition session for a patient;
means for accessing data derived from non-imaging related data for the patient; and
means for storing the imaging related and the non-imaging related data to form a patient-specific electronic medical record.

22. A system for compiling a patient-specific electronic medical record comprising:
means for accessing imaging related data derived from a medical diagnostic imaging acquisition session for a patient;
means for accessing data derived from non-imaging related data for the patient;
means for filtering and structuring at least part of the imaging related or the non-imaging related data; and
means for storing the imaging and the non-imaging data in a patient-specific electronic medical record.
